(19) United States
(12) Patent Application Publication
(10) Pub. No.: US 2024/0110602 A1
(43) Pub. Date: Apr. 4, 2024

(54) HYDRAULIC CIRCUIT FOR POWER TRANSMISSION DEVICE

(71) Applicant: HONDA MOTOR CO., LTD., Tokyo (JP)

(72) Inventors: Kotaro Hiramine, Tokyo (JP); Ryuichi Mori, Tokyo (JP); Akira Yoshida, Tokyo (JP); Robert David Morton, III, Raymond, OH (US); Matthew R. Scott, Raymond, OH (US)

(73) Assignee: HONDA MOTOR CO., LTD., Tokyo (JP)

(21) Appl. No.: 17/955,818

(22) Filed: Sep. 29, 2022

(51) Int. Cl. F16D 48/02; F15B 15/20; F16D 25/04

(52) U.S. Cl. CPC F16D 48/02; F15B 15/20; F16D 25/04; F16D 2048/0257

(57) ABSTRACT

A hydraulic circuit for a power transmission device has an oil passage supplying hydraulic pressure of hydraulic fluid to the power transmission device mounted on a vehicle and a hydraulic actuator on which the hydraulic pressure of the hydraulic fluid in the oil passage acts, the oil passage is provided with a concave portion of the inner surface of the oil passage that is recessed upward in the state of mounting on the vehicle. The concave portion is located upstream of the hydraulic actuating portion in the oil passage and above the hydraulic actuating portion when the unit is mounted in the vehicle.

### TECHNICAL FIELD

This invention relates to a hydraulic circuit for a power transmission device equipped with an oil passage supplying hydraulic pressure of hydraulic oil to a power transmission device mounted on a vehicle and a hydraulic actuator on which the hydraulic pressure of the hydraulic oil in the oil passage acts.

### BACKGROUND OF THE INVENTION

Conventionally, as shown in, for example, Patent Document 1, a hydraulic switch utilizing a diaphragm (reversing plate) that is activated by hydraulic pressure above a specified level is installed in the hydraulic piping (oil passage) that supplies hydraulic pressure of a hydraulic fluid to a transmission (power transmission device) mounted on a vehicle. This hydraulic switch is a hydraulic actuator that is activated by the hydraulic pressure of the oil circulating in the hydraulic piping.

By the way, the oil circulating in the hydraulic piping of a transmission may contain air (compressible fluid). In such a case, there is a concern that the hydraulic switch as described above may cause the reversing speed of the reversing plate to increase due to the expansion of compressed air and the contact pressure of the contacts to increase compared to oil (incompressible fluid) in which no air is mixed, which may cause wear on the electrical connections that connect them. If wear powder or rust is generated due to abrasion of electrical connections, the hydraulic switch may fail to energize or other problems may occur with prolonged use of the switch.

### PRIOR ART DOCUMENT LIST

### Patent Document

[Patent Document 1] JPA2003-106920

### SUMMARY OF THE INVENTION

### Problem to be Solved by the Invention

Therefore, conventionally, measures have been taken such as installing a gap between the hydraulic piping and the hydraulic switch so that air mixed in the oil can escape to the outside through the gap, or forming a slit in a screw attached to a hole leading to the hydraulic piping so that air mixed in the oil can escape to the outside through the slit. The slit is formed in the screw attached to the hole leading to the hydraulic piping so that air mixed with oil can escape from the slit.

However, the conventional measures described above can only be employed in areas where oil leakage is acceptable, and such a configuration itself may not be installed. Alternatively, even if it could be adopted as a configuration, there is a risk that the degree of freedom in the layout of hydraulic piping, hydraulic switches, etc. would be impeded. In addition, the need for periodic air venting requires a lot of time, effort, and cost to maintain the vehicle.

The purpose of this invention is to provide a hydraulic circuit for a power transmission device that is comparatively simple in configuration, has no risk of causing oil leakage to the outside, and can prevent hydraulic pressure of the hydraulic oil from acting on hydraulic switches and other hydraulic actuator while air or other gas is mixed in the hydraulic oil circulating in the oil circuit. Thereby, the invention contributes to the development of a sustainable transportation system and to reducing the degradation of traffic smoothness while improving the safety of vehicular traffic.

### Means for Solving the Problem

The present invention for solving the above problems is a hydraulic circuit for a power transmission device, the power transmission device including an oil passage (10) supplying hydraulic oil pressure to the power transmission device mounted on a vehicle and a hydraulic actuator (30) having a hydraulic actuating portion (31) on which the hydraulic pressure of the hydraulic fluid in the oil passage (10) acts. The hydraulic circuit including a concave portion (16) of the inner surface of the oil passage (10A) that is recessed upward in the state of being mounted on the vehicle. The concave portion (16) is located upstream of the hydraulic actuating portion (31) in the oil passage (10A) and above the hydraulic actuating portion (31) in the state of being mounted on the vehicle.

According to the hydraulic circuit of the power transmission device in this invention, the hydraulic circuit has the concave portion of the inner surface of the oil passage that is recessed upward in the state of being mounted on the vehicle, and this concave portion is located upstream of the hydraulic actuating portion in the oil passage and higher than the hydraulic actuating portion in the state of being mounted on the vehicle. This allows air and other gases mixed in the hydraulic fluid circulating in the oil passage to escape into the concave portion, despite the comparatively simple configuration. Therefore, it can effectively prevent the hydraulic pressure of the hydraulic fluid from acting on the hydraulic actuating portion of the hydraulic actuator while the hydraulic fluid circulating in the oil passage is contaminated with air or other gases. Therefore, by stabilizing the hydraulic pressure by the hydraulic oil acting on the hydraulic actuator, the operation of the actuator by the hydraulic pressure can be stabilized. The risk of malfunctioning of the hydraulic actuator over a long period of use is reduced.

In addition, the present invention is configured to allow air and other gases mixed in the hydraulic oil circulating in the oil passage to escape into the concave portion by providing the concave portion on the inner surface of the oil passage, so there is no need to leak hydraulic oil and gases in the oil passage to the outside as in the conventional structure. Therefore, it can be installed in areas where oil leakage is unacceptable, and the flexibility in the layout configuration of the hydraulic actuating device and oil passage can be increased. In addition, periodic gas venting is not required, thus reducing the time, effort, and cost of vehicle maintenance.

In this invention, the oil passage opening/closing portion (3) may be provided to allow the oil passage (10) to be connected to the outside when the oil passage (10) is opened/closed and the oil passage opening/closing portion (3) may be provided at a position lower than the concave portion (16) in the state of being mounted on the vehicle. The oil passage opening/closing portion (3) can be, for example, a pressure regulating valve configured to open only when the pressure in the oil passage (10) is lower than the external atmospheric pressure.

According to this configuration, the oil passage is equipped with the oil passage opening/closing portion that allows the oil passage to be connected to the outside, and when the oil passage opening/closing portion is opened, there is a risk that air or other gases from the outside may enter the oil passage. However, in the present invention, the oil passage opening/closing portion is located below the concave portion in the state of being mounted on the vehicle, so that even if air or other gases are mixed into the oil passage from the oil passage opening/closing portion, they will be released into the concave portion by moving upward through the oil passage. Therefore, it is possible to prevent air and other gases that enter from the oil passage opening/closing portion from mixing with the hydraulic oil acting on the hydraulic actuating portion.

In the present invention, the oil passage opening/closing portion (3) may be located upstream in the oil passage (10) from the concave portion (16).

According to this configuration, the oil passage opening/closing portion is located upstream in the oil passage from the concave portion, so that gases such as air that enter the oil passage from the oil passage opening/closing portion are released into the concave portion as they move downstream through the oil passage. Therefore, it can more effectively prevent air and other gases from mixing with the hydraulic oil acting on the hydraulic actuating portion.

The present invention may also be provided with other concave portion (17) that are recessed downward on a portion of the inner surface of the oil passage (10A) in the state of being mounted on the vehicle, and the other concave portion (17) may be located upstream of the hydraulic actuating portion (31) in the oil passage (10A) and lower than the hydraulic actuating portion (31) in the state of being mounted on the vehicle.

According to this configuration, the other concave portion of the inner surface of the oil passage are concave downward in the state of being mounted on the vehicle, so that contamination such as fine metal powder contained in the hydraulic oil circulating in the oil passage is trapped in the other concave portion, effectively preventing foreign matter from being contained in the hydraulic oil acting on the hydraulic actuating portion. Therefore, the hydraulic pressure by the hydraulic oil acting on the hydraulic actuating portion and the operation of the actuator by the hydraulic pressure can be stabilized more effectively.

In the present invention, the hydraulic actuator (30) may be a hydraulic switch (30) that is activated when the hydraulic pressure in the oil passage (10A) is above a predetermined level, or a hydraulic sensor that detects that the hydraulic pressure in the oil passage is above a predetermined level.

According to this configuration, the hydraulic actuator is a hydraulic switch that is activated when the hydraulic pressure in the oil passage is above a predetermined level, or a hydraulic sensor that detects that the hydraulic pressure in the oil passage is above a predetermined level, thereby preventing air or other gases from mixing with the hydraulic oil acting on these hydraulic switches and sensors. This effectively prevents the reversing plate equipped with the hydraulic switch and hydraulic sensor from reversing faster or the contact pressure of the contacts from increasing due to air mixed in the hydraulic oil, thereby reducing the risk of wear on the electrical connections of the hydraulic switch and hydraulic sensor. Therefore, wear powder and rust can be prevented due to abrasion of electrical connections, effectively reducing the risk of problems such as energization failure due to prolonged use of hydraulic switches and sensors.

In the present invention, the hydraulic actuator (30) may have a diaphragm (31).

According to this configuration, where the hydraulic actuating portion of the hydraulic actuator has a diaphragm, it is possible to prevent air or other gases from mixing with the hydraulic oil acting on the diaphragm, thus preventing the diaphragm from reversing faster and the contact pressure at the contact point from becoming higher. Therefore, the risk of wear on electrical connections can be reduced, thus more effectively reducing the risk of problems such as energization failure due to prolonged use of the hydraulic switch or hydraulic sensor.

It should be noted that the above numerals in parentheses indicate the drawing reference numbers of corresponding constituent elements in the embodiments described later, only for reference.

### Effect of the Invention

According to the hydraulic circuit of the power transmission device of the present invention, it has a relatively simple configuration and prevents the hydraulic pressure of the hydraulic oil from acting on hydraulic switches and other hydraulic actuator while air or other gases are mixed in the hydraulic oil circulating in the oil circuit, without risk of causing oil leakage to the outside.

### BRIEF DESCRIPTION OF DRAWINGS

FIG. 1 is a perspective view showing a schematic configuration of a hydraulic circuit of a power transmission device according to one embodiment of the present invention;

FIG. 2 is a diagram for explaining the configuration of a hydraulic switch and its surrounding oil passages;

FIG. 3 is an exploded perspective view showing an exploded state of the oil pressure switch and an attachment forming an oil passage therearound;

FIG. 4 is a perspective view showing a state in which the hydraulic switch and attachments forming a peripheral oil passage are assembled;

FIG. 5 is schematic cross-sectional view of the hydraulic switch;

FIGS. 6A and 6B are diagrams for explaining the operation of the hydraulic switch, where FIG. 6A shows a state in which the hydraulic pressure of hydraulic oil is not applied, and FIG. 6B shows a state in which the hydraulic pressure of hydraulic oil is applied.

### EMBODIMENT OF THE INVENTION

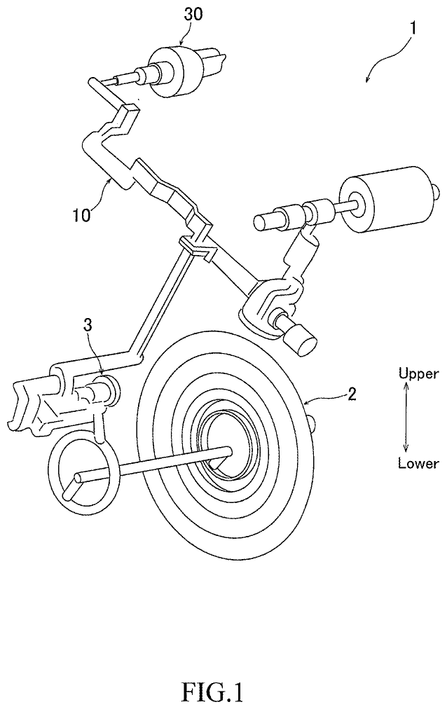

Hereinafter, embodiments of the present invention will be described in detail with reference to the accompanying drawings. FIG. 1 is a perspective view showing a schematic configuration of a hydraulic circuit of a power transmission device according to one embodiment of the present invention. As shown in the figure, the hydraulic circuit 1 of the power transmission device of one embodiment of the invention has an oil passage 10 that supplies hydraulic pressure of hydraulic oil to a clutch 2, a component of a transmission (power transmission device) mounted on a vehicle, and a hydraulic switch (hydraulic actuator) 30 on which hydraulic pressure of the hydraulic oil in the oil passage 10 acts. In addition, at a position in the vicinity of clutch 2 in oil passage 10, an air check valve (oil passage opening/closing portion) 3 is provided to return the pressure in oil passage 10 to atmospheric pressure by introducing air from the outside when the pressure in oil passage 10 becomes negative (a state of pressure lower than atmospheric pressure; the same applies hereinafter).

In this embodiment, the hydraulic switch 30 is located above the air check valve 3 when mounted on the vehicle. The hydraulic switch 30 is located downstream in the oil passage 10 from the air check valve 3.

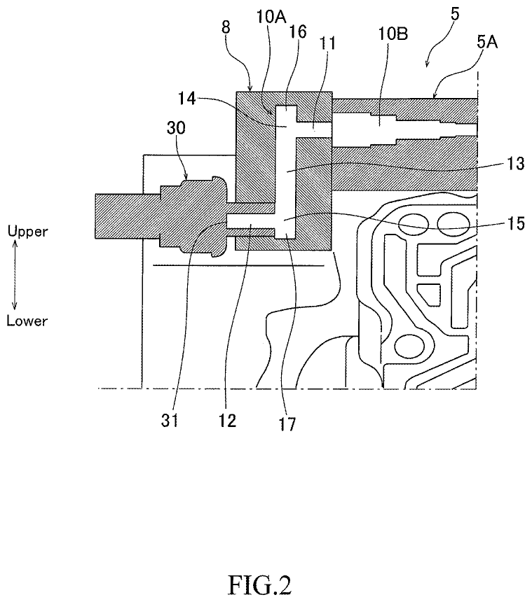

FIG. 2 is a diagram for explaining the configuration of a hydraulic switch and its surrounding oil passages. As shown in the figure, the hydraulic control unit 5, a component of the transmission, has a hydraulic control body 5A with a plurality of oil passage 10 formed inside. The hydraulic switch 30 is mounted on the side of the hydraulic control body 5A, and an oil passage 10A is connected to the hydraulic switch 30. The oil passage 10A, which is connected to the hydraulic switch 30, is formed in the attachment 8, which is interposed between the hydraulic switch 30 and the hydraulic control body 5A. The attachment 8 is a separate component that is separate from the hydraulic switch 30 and hydraulic control body 5A and can be removed to them. The oil passage 10A has an upstream oil passage 11 connected to the oil passage 10B in hydraulic control body 5A, a downstream oil passage 12 connected to a diaphragm (hydraulic actuating portion) 31 described below in the hydraulic switch 30, and a connecting oil passage 13 connecting these upstream oil passages 11 and 12. The upstream oil passage 11 and downstream oil passage 12 are formed as straight oil passages extending in an abbreviated horizontal direction (transverse direction) when mounted on a vehicle, and the connecting oil passage 13 is formed as a straight oil passage extending in an abbreviated vertical direction (longitudinal direction) when mounted on a vehicle. An upper connection 14, which connects the upstream oil passage 11 to the connecting oil passage 13, connects the downstream end of the upstream oil passage 11 to the upstream end of the connecting oil passage 13 at an abbreviated right angle, while a lower connection 15, which connects the connecting oil passage 13 to the downstream oil passage 12, connects the downstream end of the connecting oil passage 13 and the upstream end of the downstream oil passage 12 at a right angle.

Above (directly above) the upper connection 14 is an upper concave portion 16, which is a portion of the inner surface of the oil passage 10A concaved upward in the state of being mounted on the vehicle. The upper concave portion 16 extends the connecting oil passage 13 further above the upper connection portion 14, and is formed as a depression in the oil passage 10A that depresses the location of the upper connection 14 directly above.

In addition, below (directly below) the lower connection 15 is a lower concave portion 17, which is a portion of the inner surface of the oil passage 10A that is concave downward in the state of being mounted on the vehicle. The lower concave portion 17 extends the connecting oil passage 13 further down than the lower connection 15, and is formed as a depression in the oil passage 10A that depresses the location of the lower connection 15 in the oil passage 10A in a directly downward direction.

The upper concave portion 16 is located upstream of the hydraulic switch 30 in the oil passage 10A and above the hydraulic switch 30 when mounted on the vehicle. On the other hand, the lower concave portion 17 is located upstream of the hydraulic switch 30 in the oil passage 10A and lower than the hydraulic switch 30 when mounted on the vehicle.

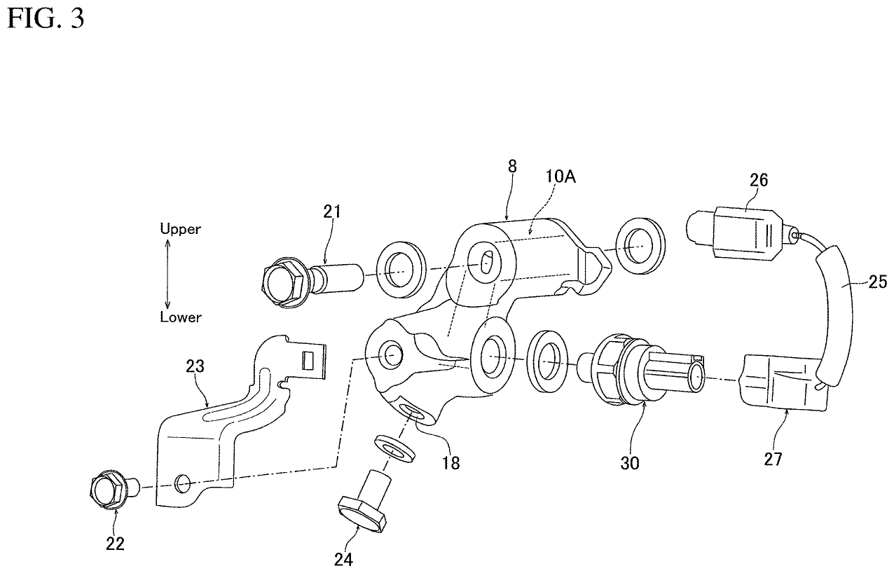

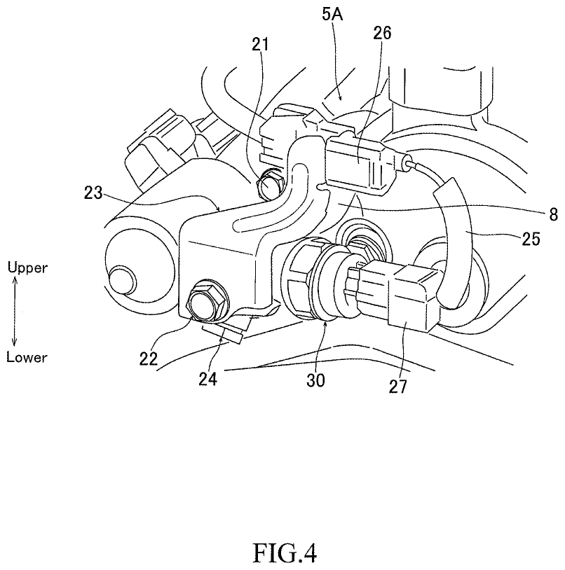

Next, a more specific configuration example of this embodiment will be described with reference to FIGS. 3 and 4. FIG. 3 is an exploded perspective view showing an exploded state of the oil pressure switch and an attachment forming an oil passage therearound. FIG. 4 is a perspective view showing a state in which the hydraulic switch and attachments forming a peripheral oil passage are assembled. As shown in these figures, the hydraulic circuit 1 in this embodiment has the hydraulic switch 30 and the attachment 8 with the oil passage 10A leading to the hydraulic switch 30. The previously described upstream oil passage 11, downstream oil passage 12, and connecting oil passage 13 are formed in the attachment 8. The attachment 8 is attached to the hydraulic control body 5A with a banjo bolt (union bolt) 21 that is inserted into the upstream oil passage 11, and is further secured to prevent misalignment by stay 23 attached from above by fastening bolt 22. A sealing bolt 24 is attached to the oil passage 10A of the attachment 8 to seal the opening 18 in the oil passage 10A. In FIG. 3 and FIG. 4, reference numeral 25 denotes a harness (signal line) connected to the hydraulic switch 30, and reference numerals 26 and 27 denote couplers (connectors) provided on the signal line.

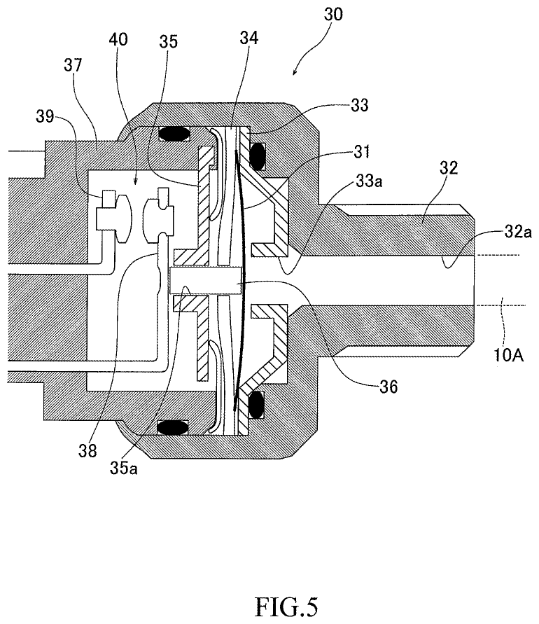

The configuration and operation of the hydraulic switch 30 will now be explained. FIG. 5 is schematic cross-sectional view of the hydraulic switch. As shown in the figure, the hydraulic switch 30 consists of the diaphragm (inverted plate) 31, which is the hydraulic actuating portion on which the pressure of the hydraulic fluid supplied from the oil passage 10A, a receiver 33 and a stopper 34 installed in the base 32 and holding the periphery of the diaphragm 31, a guide 35 supported by stopper 34, an operating axis 36 that is supported axially slidably in the center of the guide 35 and moves forward and backward in response to the actuation of the diaphragm 31, and a contact fixture 38 and terminal 39, which are located in case 37 and open and close electrical contact 40 by the movement of the operating axis 36.

The receiver 33 has an opening 33a for introducing oil pressure at its center, which is connected to the oil passage 10A upstream of the diaphragm 31 via passage 32a in the base 32. This allows the hydraulic pressure of the hydraulic fluid to act on the diaphragm 31. The diaphragm 31 is composed of a plurality of thin metal plates stacked in a disk shape with the center portion bulging out on one side, and is configured to be reversed by hydraulic pressure of hydraulic fluid introduced through the opening 33a.

A guide hole 35a is formed in the center of the guide 35 in the case 37, and the operating axis 36 can slide (move back and forth) through the guide hole 35a. In the interior space of the case 37, there is a contact fixture 38, which is supported by the guide 35 at one end and has a free end at the other end, and a terminal 39 fixed in a position opposite the contact fixture 38.

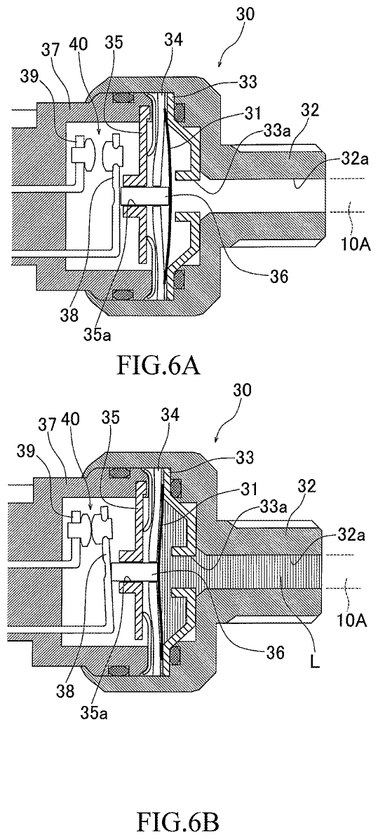

FIGS. 6A and 6B are diagrams for explaining the operation of the hydraulic switch, where FIG. 6A shows a state in which the hydraulic pressure of hydraulic oil is not applied, and FIG. 6B shows a state in which the hydraulic pressure of hydraulic oil is applied. In the hydraulic switch 30 with the above configuration, when the hydraulic pressure of the hydraulic oil is not acting on the diaphragm 31, the diaphragm 31 is not reversed (inverted) and the operating axis 36 is in the evacuated position in the guide hole 35a, as shown in FIG. 6A. On the other hand, as shown in FIG. 6B, the hydraulic pressure of the hydraulic oil L acts on the diaphragm 31, and when the hydraulic pressure exceeds a predetermined value, the diaphragm 31 reverses. The operating axis 36 pressed by the reversed diaphragm 31 protrudes to the protruding position in the guide hole 35a, causing the contact fixture 38 pressed by the operating axis 36 to move to the left in the same figure, contacting the contact fixture 38 and the terminal 39 to conduct the electrical contact 40.

If air is mixed in the hydraulic oil circulating in oil passage 10A, the reversal speed of the diaphragm 31 may increase due to the expansion of compressed air and the contact pressure of electrical contact 40 may increase compared to hydraulic oil without air (incompressible fluid), which may cause wear to the connecting contact fixture 38 and terminal 39 (electrical contact 40). If wear powder or rust occurs due to wear of the contact fixture 38 and terminal 39, problems such as poor energization may occur with prolonged use of the hydraulic switch 30. However, the hydraulic circuit 1 of this embodiment is equipped with the upper concave portion 16 in which a portion of the inner surface of the oil passage 10A is concaved upward in a vehicle-mounted condition, allowing air and other gases mixed in the hydraulic oil circulating in the oil passage 10A to escape into the upper concave portion 16, thus preventing the hydraulic pressure of the hydraulic oil concerned from acting on the diaphragm 31 of the hydraulic switch 30 while air and other gases are mixed in the hydraulic oil circulating in the oil passage 10A.

In other words, this embodiment has the upper concave portion 16, which is a portion of the inner surface of oil passage 10A concaved upward in the vehicle-mounted condition, and this upper concave portion 16 is located upstream of the diaphragm 31 of hydraulic switch 30 in oil passage 10A and above the diaphragm 31 in the vehicle-mounted condition, allowing air and other gases mixed in hydraulic oil circulating in oil passage 10A to escape into the upper concave portion 16, even with a relatively simple configuration. Therefore, it can effectively prevent the hydraulic pressure of the hydraulic oil from acting on the diaphragm. 31 of the hydraulic switch 30 while air or other gases are mixed with the hydraulic oil circulating in the oil passage 10A. Therefore, the hydraulic pressure from the hydraulic oil acting on the diaphragm 31 and the operation of the electrical contact 40 due to the hydraulic pressure can be stabilized, reducing the risk of malfunctions such as operation failure in the hydraulic switch 30 over a long period of use.

In addition, in this embodiment, the upper concave portion 16 is provided on the inner surface of the oil passage 10A to allow air and other gases mixed in the hydraulic oil circulating in the oil passage 10A to escape into this upper concave portion 16, so there is no need to leak hydraulic oil and gases in the oil passage to the outside as in conventional structures. Therefore, the oil passage structure with this upper concave portion 16 can be employed in areas where oil leakage cannot be tolerated, and the degree of freedom in the arrangement configuration of the hydraulic switch 30 and oil passage 10A can be increased. In addition, periodic air venting is not required, thus reducing the time, effort, and cost of vehicle maintenance.

Further, in this embodiment, as described above, the air check valve 3 is provided for introducing air from the outside and returning the pressure to the atmospheric pressure when the inside of the oil passage 10 becomes negative pressure. The air check valve 3 is an oil passage opening/closing portion that opens and closes the oil passage 10, allowing the oil passage 10 to be connected to the outside. The air check valve 3 is located lower than the upper concave portion 16 when mounted on the vehicle.

By providing an air check valve 3 to return the oil passage 10 to atmospheric pressure by introducing air from outside when the oil passage 10 becomes negative pressure, there is a risk that air or other gases from outside may enter the oil passage 10 when the air check valve 3 is opened. However, in this embodiment, the air check valve 3 is installed at a position lower than the upper concave portion 16 when mounted on the vehicle, so that even if air or other gas is mixed into the oil passage 10 from the air check valve 3, the gas will be released into the upper concave portion 16 by moving upward through the oil passage 10. Therefore, air and other gases that enter through the air check valve 3 are prevented from mixing with the hydraulic fluid acting on the diaphragm 31.

In this embodiment, the air check valve 3 is located upstream in the oil passage 10 from the upper concave portion 16.

According to this configuration, the air check valve 3 is located upstream in the oil passage 10 from the upper concave portion 16, so that gases such as air that have entered the oil passage 10 from the air check valve 3 are released into the upper concave portion 16 by moving downstream through the oil passage 10. Therefore, air can be more effectively prevented from mixing with the hydraulic fluid acting on the diaphragm 31.

In this embodiment, the oil passage 10A is provided with the lower concave portion (other concave portion) 17, which is a portion of the inner surface of the oil passage 10A concaved downward in the vehicle-mounted condition. The lower concave portion 17 is located upstream of the diaphragm 31 of the hydraulic switch 30 in the oil passage 10A, and lower than the diaphragm 31 of the hydraulic switch 30 in the vehicle-mounted condition.

According to this configuration, the lower concave portion 17, which is a portion of the inner surface of oil passage 10A that is concaved downward when mounted on a vehicle, allows foreign matter such as fine metal powder (contamination) contained in the hydraulic oil circulating in oil passage 10A to be trapped by the lower concave portion 17, effectively preventing such foreign matter from being contained in the hydraulic oil acting on the diaphragm 31 of the hydraulic switch 30. Therefore, the hydraulic pressure due to the hydraulic oil acting on the diaphragm 31 and the operation of the actuator by the hydraulic pressure can be stabilized more effectively.

In addition, the hydraulic actuator in this invention is a hydraulic switch 30 that is activated when the hydraulic pressure in the oil passage 10A is above a certain level, which prevents air or other gases from mixing with the hydraulic oil acting on the diaphragm 31 of the hydraulic switch 30. This effectively prevents the diaphragm 31 from reversing faster and the contact pressure of the electrical contact 40 from increasing due to air mixed in the hydraulic oil, thereby reducing the risk of wear on the electrical contact 40 of the hydraulic switch 30. Therefore, wear powder and rust can be prevented due to wear of the electrical contact 40, effectively reducing the risk of problems such as energization failure due to prolonged use of the hydraulic switch 30.

In addition, where the hydraulic actuating portion of the hydraulic switch has a diaphragm 31, the hydraulic oil acting on this diaphragm 31 can be prevented from being mixed with air or other gases, which can increase the reversal speed of the diaphragm 31 and increase the contact pressure of the electrical contact 40. Therefore, the risk of wear on the contact fixture 38 and terminal 39 (electrical contact 40) can be reduced, thus more effectively reducing the risk of problems such as energization failure due to prolonged use of the hydraulic switch 30.

Although the embodiments of the present invention have been described above, the present invention is not limited to the above embodiments, and various modifications can be made within the scope of the technical ideas described in the claims, the specification and the drawings. For example, in the above-described embodiment, the hydraulic switch 30 that operates when the hydraulic pressure in the oil passage 10 is equal to or higher than a predetermined value is shown as the hydraulic operating device of the present invention. However, the hydraulic operating device of the present invention may be a hydraulic sensor or the like that detects that the hydraulic pressure in the oil passage is equal to or higher than a predetermined value.

1. A hydraulic circuit for a power transmission device, the power transmission device comprising,
an oil passage supplying hydraulic oil pressure to a power transmission device mounted on a vehicle, and
a hydraulic actuator comprising a hydraulic actuating portion on which the hydraulic pressure of the hydraulic fluid in the oil passage acts,
wherein the hydraulic circuit comprises a concave portion of the inner surface of the oil passage that is recessed upward in the state of being mounted on the vehicle,
wherein the concave portion is located upstream of the hydraulic actuator in the oil passage and above the hydraulic actuator in the state of being mounted on the vehicle.

2. The hydraulic circuit of the power transmission device according to claim 1,
an oil passage opening/closing portion is provided to allow the oil passage to be connected to the outside when the oil passage is opened/closed,
wherein the oil passage opening/closing portion is provided at a position lower than the concave portion in the state of being mounted on the vehicle.

3. The hydraulic circuit of the power transmission device according to claim 2,
wherein the oil passage opening/closing portion is located upstream in the oil passage from the concave portion.

4. The hydraulic circuit of the power transmission device according to claim 1,
the oil passage is provided with other concave portion,
wherein a portion of the inner surface of the oil passage is recessed downward in the state of being mounted on the vehicle,
wherein the other concave portion is located upstream of the hydraulic actuator in the oil passage and lower than the hydraulic actuator in the state of being mounted on the vehicle.

5. The hydraulic circuit of the power transmission device according to claim 1,
wherein the hydraulic actuator is a hydraulic switch that is activated when the hydraulic pressure in the oil passage is above a predetermined level, or a hydraulic sensor that detects when the hydraulic pressure in the oil passage is above a predetermined level.

6. The hydraulic circuit of the power transmission device according to claim 5,
wherein the hydraulic actuator comprises a diaphragm.

7. The hydraulic circuit of the power transmission device according to claim 2,
wherein the oil passage opening/closing portion is a pressure regulating valve configured to open only when the pressure in the oil passage is lower than the external atmospheric pressure.
